(19) United States
(12) Patent Application Publication
(10) Pub. No.: US 2008/0040160 A1
(43) Pub. Date: Feb. 14, 2008

(54) Medical Treatment Compliance Monitoring System

(75) Inventors: Harm Jacob Scherpbier, Fort Washington, PA (US); Laura Koetter, Phoenixville, PA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS MEDICAL SOLUTIONS USA, INC., MALVERN, PA (US)

(21) Appl. No.: 11/740,435

(22) Filed: Apr. 26, 2007

Related U.S. Application Data
(60) Provisional application No. 60/747,215, filed on May 15, 2006.

(51) Int. Cl. G06F 19/00

(52) U.S. Cl. 705/3

(57) ABSTRACT

A Workflow Management System is integrated with a Healthcare Information System to perform compliance contemporaneously with change in patient conditions. A medical treatment compliance monitoring system includes an input processor for receiving information identifying a patient and a medical condition of the patient. A workflow task processor provides a healthcare worker with information indicating treatment activity to be performed for the patient. The treatment activity conforms with recommended guidelines for treating the medical condition. The workflow task processor also prompts the healthcare worker to complete documentation, indicating an action taken by the healthcare worker in treating the patient, and documenting compliance with the recommended guidelines. The healthcare worker is prompted to complete the documentation at a time substantially close to the time of the action being taken by the healthcare worker.

This is a non-provisional application of provisional application Ser. No. 60/747,215 by H. J. Scherpbier et al. filed May 15, 2006.

### FIELD OF THE INVENTION

This invention concerns a compliance monitoring and documentation system for documenting compliance with recommended treatment guidelines concurrently with, or substantially close to the time of, treatment of an acute medical condition such as a Myocardial Infarction.

### BACKGROUND OF THE INVENTION

In existing systems, treatment related metrics (e.g., metrics compatible with JCAHO and CMS) are typically collected after a patient stay and after the patient is discharged. This creates a problem in that non-compliance cannot be undone since a patient has already been discharged and left a healthcare organization premises. Further, missing documentation may be hard to find, may not exist, or may be difficult or impossible to re-create after the patient has left. The JCAHO (Joint Commission on Accreditation of Healthcare Organizations) accredits healthcare organizations and programs in the United States, sets standards in health care to improve quality and safety of care provided by health care organizations and evaluates organization compliance with standards and accreditation requirements. CMS are the Centers for Medicare and Medicaid Services a US federal agency which administers Medicare, Medicaid, and the State Children's Health Insurance Program and provides information for health professionals. JCAHO/CMS compliance measurements are typically collected after patient discharge, by abstractors, going through patient records (electronic, paper, or hybrid) to derive appropriate data. In the case of patients admitted with Acute Myocardial Infarction (AMI), for example, the abstractors find a patient chart and fill out a form with the information needed for submission to the JCAHO. Often, information is missing, which results in a missed item on a submission and thus a lower compliance level.

In known systems, a patient is typically already discharged, so actions cannot be corrected (if a patient should have received aspirin upon admission but did not, for example, it is too late to correct) and missing documentation cannot be re-created. Even if the patient correctly received aspirin upon admission but it was not documented, the treatment is not admissible to count towards a measure of compliance. Retrospective data collection is also labor intensive and requires dedicated patient chart abstractors. A system according to invention principles addresses these deficiencies and related problems.

### SUMMARY OF THE INVENTION

A Workflow Management System is integrated with a Healthcare Information System to facilitate compliance with JCAHO/CMS Acute Myocardial Infarction (AMI) National Hospital Quality Measures, for example, by performing a ICAHO compliance measurement process contemporaneously with change in patient conditions associated with treatment of AMI and while improvements can still be made. A medical treatment compliance monitoring system includes an input processor for receiving information identifying a patient and a medical condition of the patient. A workflow task processor provides a healthcare worker with information indicating treatment activity to be performed for the patient that conforms with recommended guidelines for treating the medical condition. The workflow task processor also prompts the healthcare worker to complete documentation, indicating an action taken by the healthcare worker in treating the patient, and documenting compliance with the recommended guidelines. The healthcare worker is prompted to complete the documentation at a time substantially close to the time of the action being taken by the healthcare worker.

### BRIEF DESCRIPTION OF THE DRAWING

FIG. 1 shows a medical treatment compliance monitoring system, according to invention principles.

FIG. 2 shows an Acute Myocardial Infarction (AMI) task sequence (workflow), according to invention principles.

FIG. 3 shows an Acute Myocardial Infarction (AMI) workflow for monitoring Aspirin intake upon patient admission (a JCAHO/CMS care measure), according to invention principles.

FIG. 4 shows a user interface display image prompting care measure documentation for a potential AMI patient, according to invention principles.

FIG. 5 shows a user interface display image illustrating a for use in care measure documentation for a potential AMI patient, according to invention principles.

FIGS. 6 and 7 illustrate more detail of the FIG. 5 form for use in care measure documentation for a potential AMI patient, according to invention principles.

FIG. 8 shows a user interface display image prompting a user to take a care measure compatible with JCAHO/CMS guidelines, according to invention principles.

FIG. 9 shows a flowchart of a process performed by a medical treatment compliance monitoring system, according to invention principles.

### DETAILED DESCRIPTION OF THE INVENTION

A system implements a JCAHO/CMS compatible monitoring, compliance and documentation process for AMI, for example, using a Workflow Management System integrated with (or part of) a Healthcare Information System (HIS). Acute myocardial infarction (AMI), or heart attack, refers to necrosis (death) of myocardial tissue that results from ischemia (deprivation of oxygen) associated with sudden, prolonged diminished blood flow. The compliance and documentation process identifies patients with ANI, notifies clinicians of actions needed for maximum compliance with JCAHO/CMS AMI measures and captures documentation of these actions while they are taking place. Although embodiments herein are described in the context of AMI, this is exemplary only and the embodiments are applicable to other medical conditions and treatments. A workflow processor (comprising a Workflow Management System) supports documentation of actions (for compliance) and performance of the actions by prompting a clinician to perform an action at the correct time and concurrently capture the documentation. The Workflow processor also escalates action to acquire missing information while a patient is still in a hospital and continuously improves care by evaluating degree of compliance using captured documentation and identifying care actions needing improvement. In operation, the system alerts a nurse or physician that a patient just admitted with an AMI should receive aspirin and concurrently captures documentation indicating a clinician administered the aspirin or alternatively concurrently captures documentation indicating a clinically valid reason why the action was not performed, thereby supporting compliance. The system supports completion of documentation on-line in real-time and avoids a need to refer to historical patient charts and reduces time taken by an abstractor to collect data for documentation by providing on-line forms that track patient AMI treatment.

The Workflow processor is integrated with a Healthcare Information System and tracks relevant patient data and provides access to the patient data to multiple clinicians associated with patient care. The Workflow processor implements JCAHO/CMS Acute Myocardial Infarction (AMI) National Hospital Quality Measures, for example. The system moves a JCAHO measurement process from a retrospective after the fact process, to a concurrent process that occurs contemporaneously with change in patient condition associated with treatment of AMI and while improvements can still be made.

A processor, as used herein, operates under the control of an executable application to (a) receive information from an input information device, (b) process the information by manipulating, analyzing, modifying, converting and/or transmitting the information, and/or (c) route the information to an output information device. A processor may use, or comprise the capabilities of, a controller or microprocessor, for example. The processor may operate with a display processor or generator A display processor or generator is a known element for generating signals representing display images or portions thereof. A processor and a display processor may comprise a combination of, hardware, firmware, and/or software.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A user interface (UI), as used herein, comprises one or more display images, generated by a display processor enabling user interaction with a processor or other device and associated data acquisition and processing functions. The UI also includes an executable procedure or executable application. The executable procedure or executable application conditions the display processor to generate signals representing the UI display images. These signals are supplied to a display device which displays the image for viewing by the user. The executable procedure or executable application further receives signals from user input devices, such as a keyboard, mouse, light pen, touch screen or any other means allowing a user to provide data to a processor. The processor, under control of the executable procedure or executable application manipulates the UI display images in response to the signals received from the input devices. In this way, the user interacts with the display image using the input devices, enabling user interaction with a processor or other device. The activities herein may be performed automatically or wholly or partially in response to user command. An automatically performed activity is performed in response to machine instruction or operation without direct user interaction in initiating the activity.

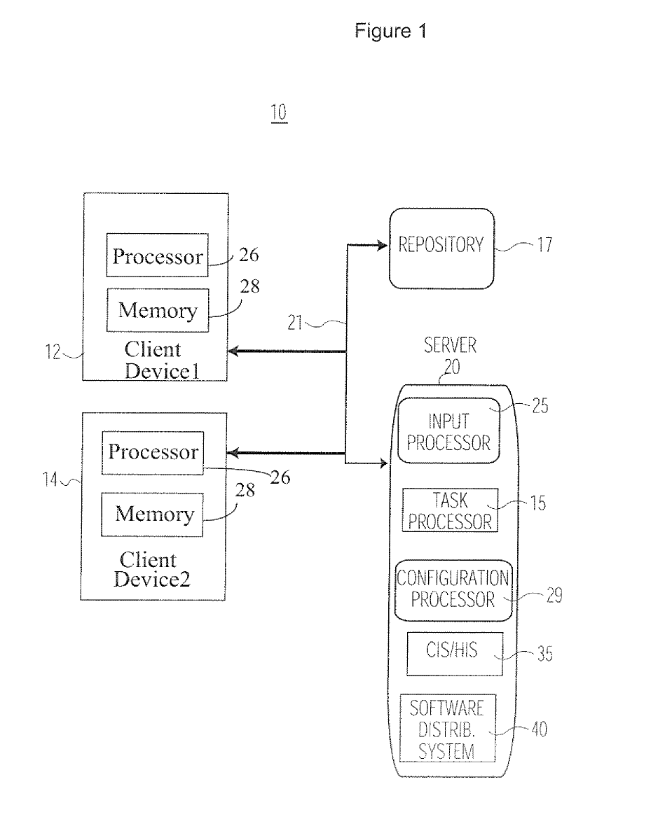

FIG. 1 shows medical treatment compliance monitoring system 10. Compliance monitoring system 10 includes client devices (workstations) 12 and 14, repository 17 and server 20. Repository 17 (comprising one or more local or remote databases) includes electronic patient medical records, data representing recommended guidelines for treating different medical conditions, treatment orders placed by physicians for patients and patient treatment plans and documentation indicating compliance with recommended treatment guidelines. Server 20 includes input processor 25 for receiving information identifying a patient and a medical condition of the patient. Workflow task processor 15 provides a healthcare worker with information indicating treatment activity to be performed for the patient. The treatment activity conforms with recommended Guidelines for treating the medical condition. Workflow task processor 15 prompts the healthcare worker to complete documentation, indicating an action taken by the healthcare worker in treating the patient, and documenting compliance with the recommended guidelines. The healthcare worker is prompted to complete the documentation at a time substantially close to the time of the action being taken by the healthcare worker and prior to discharge of the patient from a hospital. Server 20 and its supported processors as well as repository 17 may comprise multiple servers, processing devices and databases accessible and communicating via network 21, for example.

Configuration processor 29 executes a configuration application enabling a user to configure a process definition and associated trigger events employed by workflow task processor 15 in implementing processes comprising sequences of process steps for performance by a device and or worker, for example. Workflow processor 15 (a Workflow Management System or Workflow Engine), processes data to determine tasks to add to a task list, remove from a task list or modifies tasks incorporated on, or for incorporation on, a task list. A task list is a list of tasks for performance by a worker or device or a combination of both. Workflow processor 15 executes in response to predetermined process definitions that implement processes responsive to events and event associated data. Workflow processor 15 implements processes in sequence and/or concurrently, responsive to event associated data to determine tasks for performance by a device and or worker and for updating task lists of a device and a worker to include determined tasks. A process definition is definable by a user and comprises a sequence of process steps including one or more, of start, wait, decision and task allocation steps for performance by a device and or worker, for example. An event is an occurrence affecting operation of a process implemented using a process definition.

Workflow processor 15 includes a Workflow Management System, a software system that manages processes. It includes a process definition function that allows users to define a process that is to be followed for treating AMI, for example. An Event Monitor in processor 15 captures events from Healthcare Information System 35 and communicates the results to Workflow processor 15. Such events include patient admission to a hospital, start of documentation of an activity or ordering a medication to be administered to a patient, for example. A processor in the Management System tracks which processes are running, for which patients, and what step needs to be executed next, according to a process definition. The Management System includes a procedure for notifying clinicians of a task to be performed, through their worklists and a procedure for allocating and assigning tasks to specific users or specific teams. The Management System provides a process that manages clinicians in execution of tasks and documenting performance of tasks or reasons for non-performance of tasks.

The system 10 devices are interconnected and bidirectionally communicate via network 21 such as a LAN (Local Area Network) or other type of network. A client device (workstation) 12 or 14 includes processor 26 and memory unit 28 and may comprise a personal computer, for example. A user is able create, maintain and manage a process definition and associated trigger events using configuration processor 29 via one or more user interface images displayed on client device 12 or 14. Compliance monitoring system 10 may be used by a healthcare provider that is responsible for monitoring the health and/or welfare of people in its care. Examples of healthcare providers include, without limitation, a hospital, a nursing home, an assisted living care arrangement, a home health care arrangement, a hospice arrangement, a critical care arrangement, a health care clinic, a physical therapy clinic, a chiropractic clinic, and a dental office. Examples of the people being serviced by the healthcare provider include, without limitation, a patient, a resident, and a client.

Workflow processor 15 is linked (or integrated with) clinical information system (a Healthcare Information System) 35. Workflow processor 15 operates in response to a Process Definition that defines actions to be taken for a patient with an AMI according to JCAHO/CMS guidelines, for example, to optimize measurements and compliance with the guidelines. Clinical information system 35 is a software system that acquires and stores patient clinical data, provides access to clinical information to healthcare workers of a healthcare provider organization such as nurses and doctors and allows workers to order tests, medications or treatments for a patient. Clinical information system 35 presents forms to users via workstation 12 or 14 enabling a user to enter documentation for the patient indicating data identifying which tests were ordered, the medical condition of the patient, reasons for ordering medications or not ordering medications etc.

Workflow processor 15 in response to a Process Definition determines actions to be taken for a patient with an AMI and optimizes measurements, documentation and compliance with JCAHO/CMS guidelines. Workflow processor 15 implements a process that identifies candidate patients admitted to a hospital/clinic with an AMI (Acute Myocardial Infarction). Processor 15 identifies candidate patients by evaluating a chief complaint of a patient, specific patient laboratory test values, admitting diagnosis, previous patient history information, or a combination of this information. Processor 15 provides an early identification of candidate patients and initiates a process of tracking performance and documentation of JCAHO/CMS compatible AMI measurements for a patient. Processor 15 notifies clinicians to perform specific actions for a patient, according to the JCAHO/CMS AMI measurement specifications. These include, for example, administering aspirin on day of admission, administering beta blockers on day of admission, providing smoking cessation counseling if a patient is a smoker, etc. in accordance with a definition of an AMI measurement set provided by JCAHO. Further, processor 15 adaptively and dynamically updates the process for tracking performance and documentation of JCAHO/CMS compatible AMI measures in response to updates or changes to the JCAHO/CMS AMI measures and new versions of the measures.

Processor 15 captures documentation such as a form completed by a clinician that performs an AMI treatment action (e.g., a nurse or physician) substantially at the time the action is performed. Processor 15 prompts a clinician to perform a task and to access and complete a documentation form that is already automatically partially filled out (pre-populated) with previously collected information indicating characteristics associated with the action performed. For example, a clinician is prompted to document a treatment action such as indicating the clinician provided aspirin on the first day of admission and smoking cessation counseling and if it was not provided, to indicate why not (patient allergic etc.). Documenting why actions were not taken is a valid response and indicates compliance with JCAHO/CMS metrics (unlike an undocumented decision which does not count toward compliance in a measurement).

System 10 optimizes and collates data concurrently with clinician performance of treatment actions for a patient while the patient is in a hospital which results in better performance (doing the right thing for the patient, and better documentation). System 10 acquires the documentation from clinicians who provide care and perform the treatment actions and not from an abstractor after a substantial delay following treatment or after the patient is discharged. System 10 advantageously employs a clinical information system to accelerate and facilitate acquiring compliance documentation at the point of care. Workflow processor 15 manages the process and allows the system to track and monitor patient treatment in relation to a best practice, e.g., JCAHO guideline. Processor 15 identifies treatment steps to be completed, notifies clinicians responsible for the steps and identifies and escalates alerts identifying treatment variances from the guidelines to supervisory staff. Processor 15 manages the process by determining which patients to track, identifying staff to be notified and given tasks to perform for particular patients and also identifying steps that are completed and those needing completion and escalation if necessary.

In contrast, known systems provide retrospective, labor intensive, and after the fact compliance documentation. System 10 advantageously supports flexible compliance documentation acquisition that adapts to existing localized hospital organization processes and dynamically adapts to changing JCAHO/CMS AMI treatment guidelines, for example. System 10 advantageously reduces need for full-time staff presence and the associated cost involved in an inflexible hard-coded software application supporting compliance documentation involving manual documentation and human tracking. System 10 in other embodiments employs other guidelines for the treatment of Acute Myocardial Infarction, for example, guidelines provided by other regulatory bodies, or the regulatory bodies of other countries. System 10 in other embodiments employs other measurement sets and clinical treatments and guidelines for different medical conditions (other than AMI) from JCAHO/CMS and other bodies. System 10 is employed where a pre-defined process is to be followed in treatment of a patient involving coordination and management of various members of a healthcare worker team. Workflow processor 15 is advantageously integrated with a Healthcare Information System (including a clinical information system) 35 to support implementation of JCAHO/CMS compatible guidelines. Workflow processor 15 initiates necessary clinical treatment actions for patients and capture of documentation indicating that the actions were completed, or if not, reasons why the actions were not completed. System 10 is used in hospitals, as part of (or in conjunction with) a Healthcare Information System and Workflow processor.

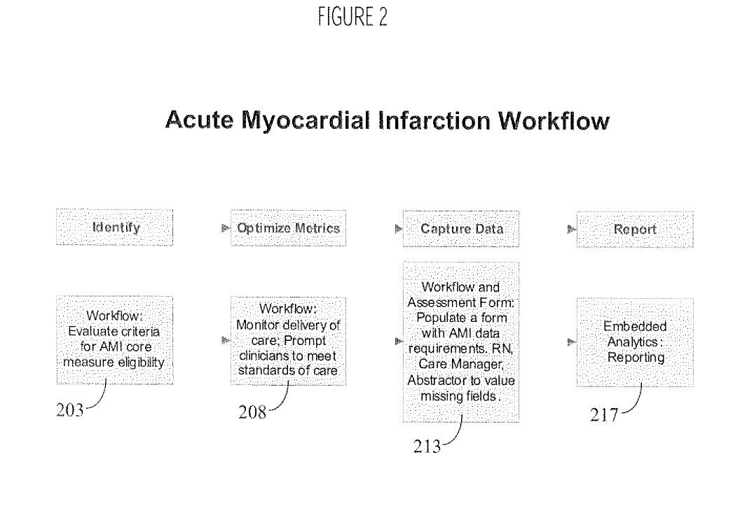

FIG. 2 shows a JCAHO/CMS compatible Acute Myocardial Infarction (AMI) task sequence (workflow) implemented using workflow processor 15. Processor 15 initiates the workflow for inpatients and Emergency Department (ED) patients. In step 203, processor 15 analyzes patient data by comparing against JCAHO/CMS compatible guideline criteria to determine if patient parameters indicate a patient has AMI. Specifically, processor 15 identifies potential AMI patients based on elevated Creatine Kinase Isoenzyme MB (CKMB) and Troponin I values. Processor 15 waits for physician data entry indicating a patient is not an AMI patient by indicating a patient is to be treated with Comfort Measures Only or is not an AMI patient, for example. In response to physician data entry indicating a patient is excluded from an AMI population, measures of care are not monitored. In step 208, processor 15 monitors clinician application of select JCAHO/CMS measures of care including, for example, administration of aspirin to a patient upon admission to a hospital, administration of a Beta Blocker upon admission providing Smoking Cessation Education.

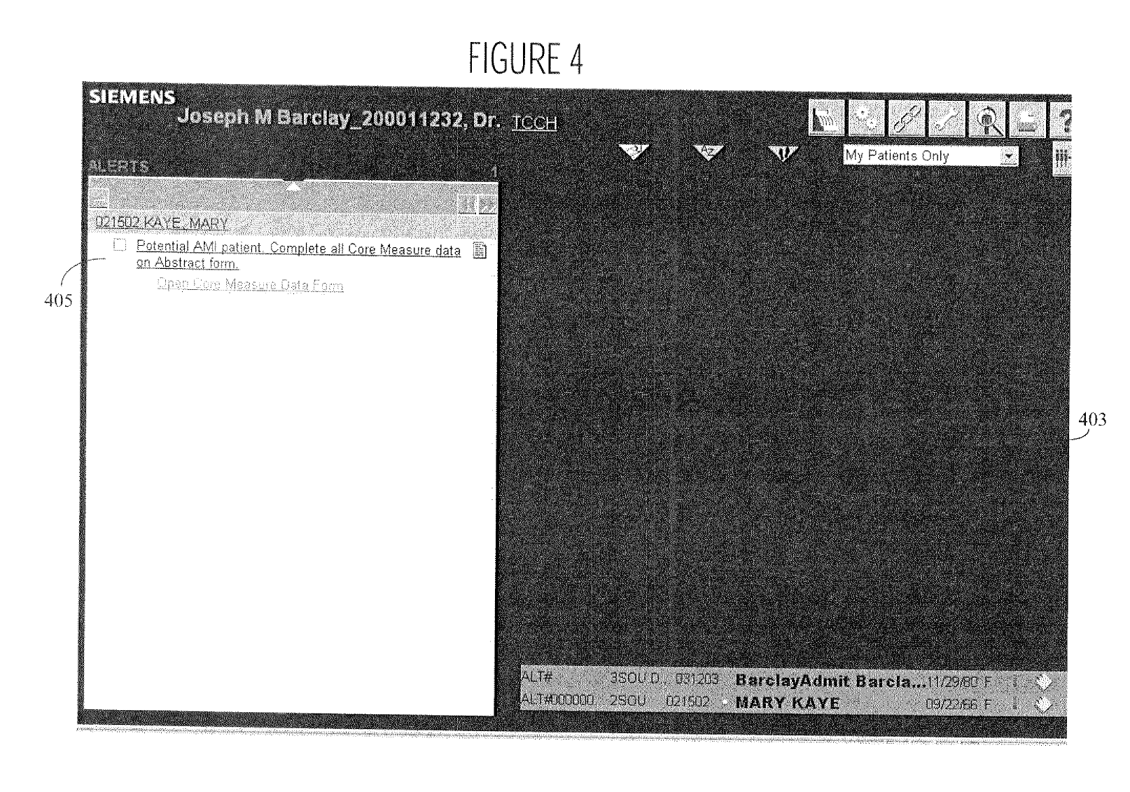

Processor 15 prompts a clinician via a display image presented on workstation 12 or 14 to provide documentation indicating treatment actions in compliance with guidelines and to enter data indicating reasons for not monitoring other care measures (real-time ECG data and discharge orders may not be available in the system). FIG. 4 shows user interface display image 403 prompting care measure documentation for a patient potentially having AMI. Image 403 shows alert indicator link 405 presented to a nurse, Care Manager and Abstractor when a potential AMI patient has been identified and core measure data is to be documented. In response to user selection of alert indicator link 405 a core AMI measure, data collection form enabling documenting performance of the AMI care measures is accessible. In step 213 processor 15 waits 24 hours before sending the core AMI measure data collection form to a nurse, Care Manager and Abstractor to enter JCAHO/CMS compatible required data during a patient visit. Processor 15 initiates generation of a display image presented on workstation 12 or 14 and including the form pre-populated with AMI data requirements and requesting data be entered in particular (or empty) data fields by the nurse, care manager or abstractor.

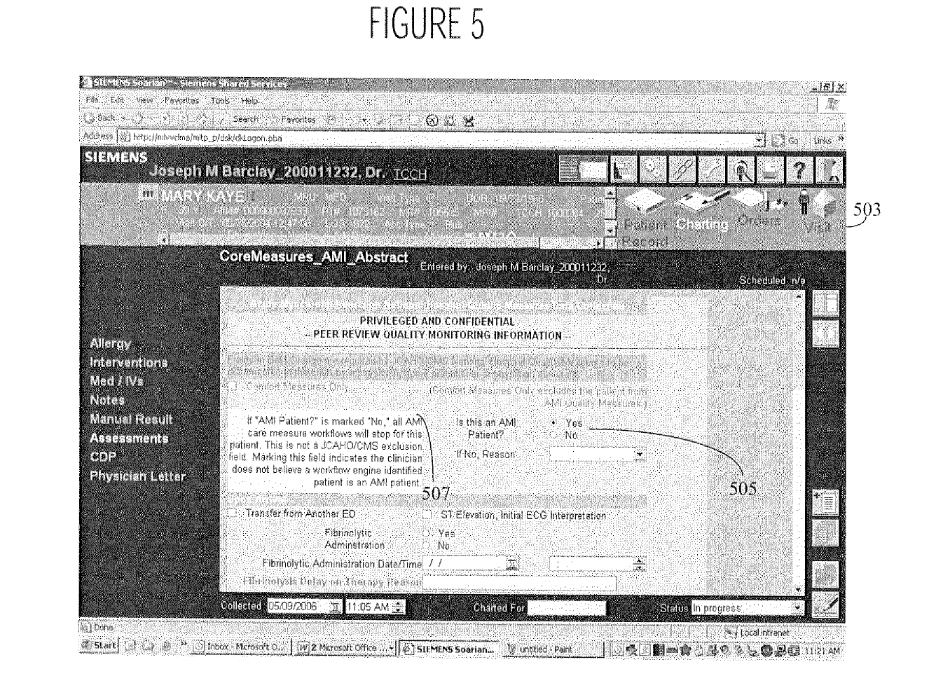

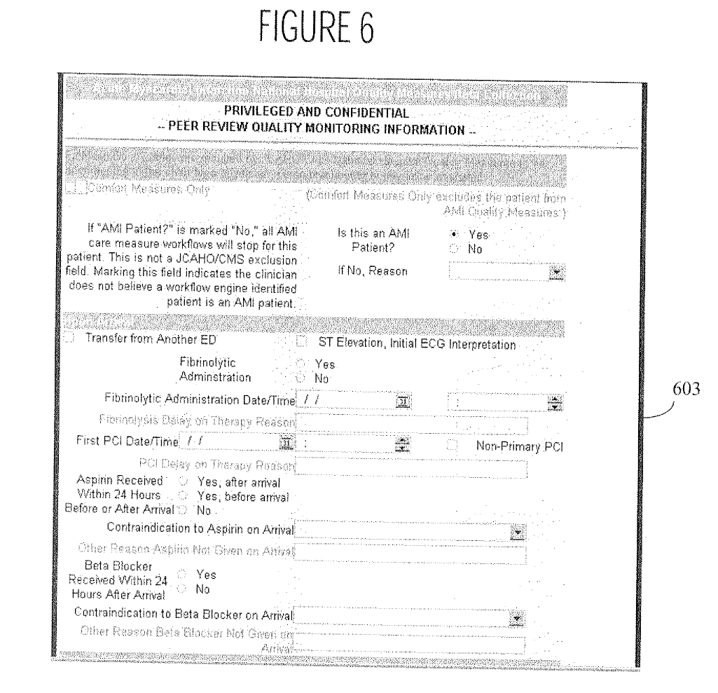

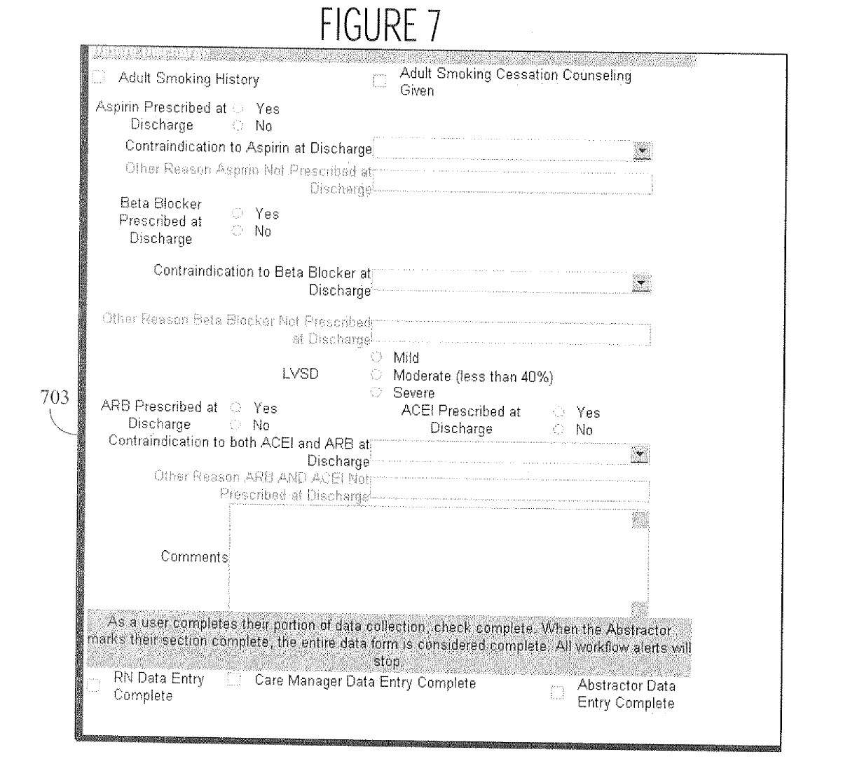

FIG. 5 shows user interface display image 503 illustrating a form for use in care measure documentation for a potential AMI patient. A user indicates a patient is an AMI patient in selectable option 505 and is guided by instruction in area 507. Processor 15 implements a workflow sub-procedure that initiates repetitively sending the form to a nurse. Care Manager and Abstractor daily at 7 am until data entry is complete, for example. FIGS. 6 and 7 show user interface display images 603 and 703 respectively, illustrating more detail of the FIG. 5 form for use in care measure documentation for a potential AMI patient. In step 217 (FIG. 2) processor 15 initiates analysis of the collected compliance data to determine areas for optimization and suggest improvement to the AMI treatment process.

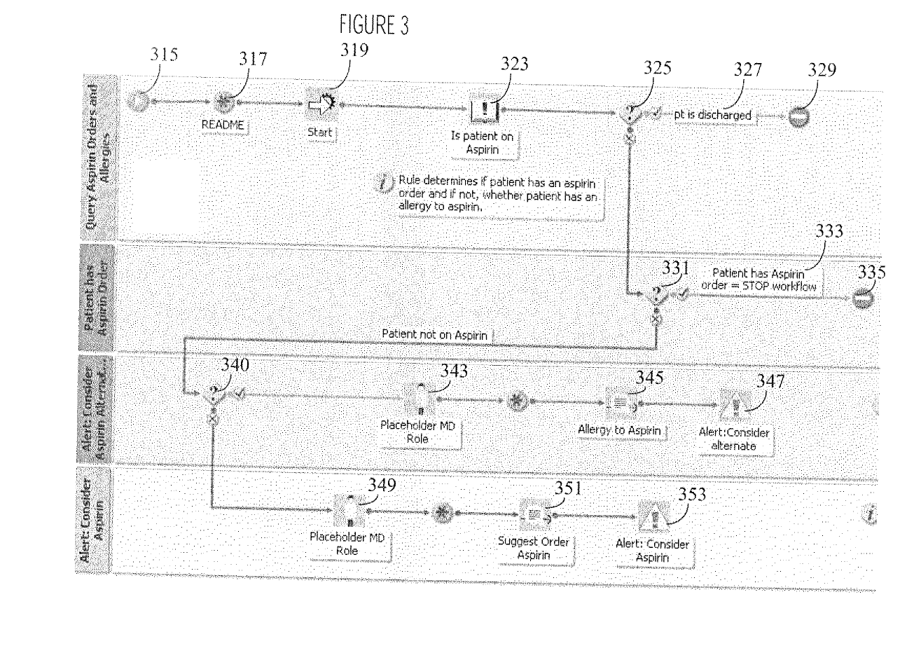

FIG. 3 shows an Acute Myocardial Infarction (AMI) workflow implemented by processor 15 for monitoring Aspirin intake upon patient admission (a JCAHO/CMS care measure) that comprises a sub-procedure of the FIG. 2 workflow. Following the start at step 315 and presentation of instructional data in step 317, processor 15 queries one or more databases for Aspirin orders and allergy information of a patient in step 323. Specifically, processor 15 determines if a patient has a current order or prescription for receiving Aspirin. In step 325 if it is determined the patient is receiving Aspirin and the patient is to be discharged in step 327, the process terminates in step 329. In step 331, if it is determined that even though the patient is not currently receiving Aspirin, there is an order for the patient to receive Aspirin, the workflow process is terminated in step 333 and finishes in step 335. In step 340, following a determination the patient is not receiving Aspirin in step 331, an alert message requesting a physician to evaluate whether the patient has an allergy to Aspirin is placed on a physician task list in step 343.

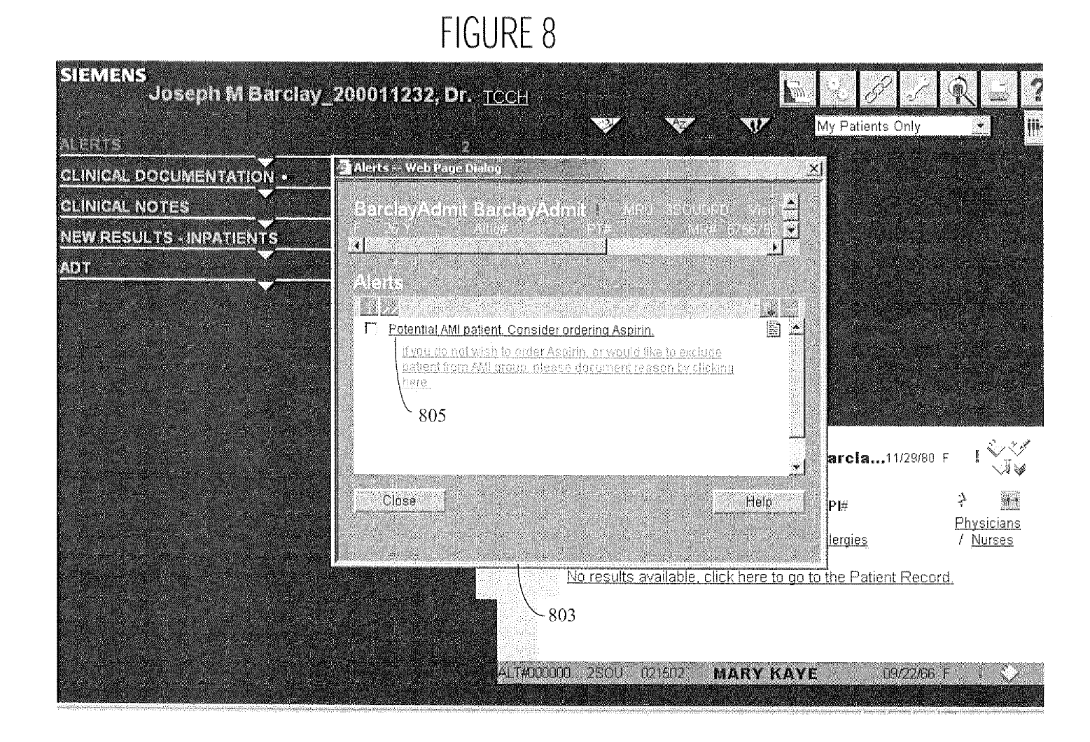

FIG. 8 shows user interface display image 803 prompting a user to take a care measure compatible with JCAHO/CMS guidelines. Alert indicator 805 is provided to a physician if a JCAHO/CMS care measure has not been met such as if a potential AMI patient does not have an Aspirin order. Further, if it is determined the patient has an allergy to Aspirin in step 345, an alert message indicating the allergy is placed on a physician task list in step 347 to prompt physician action to find an alternative medication. In step 340, following a determination the patient is not receiving Aspirin in step 331 and the patient is not allergic to Aspirin, an alert message requesting a physician to evaluate whether the patient should receive Aspirin is placed on a physician task list in step 349. Also, if it is determined the patient is to receive Aspirin in step 349, a candidate order for Aspirin for the patient is generated in step 351 and an alert message providing the candidate order is placed on a physician task list in step 353 to prompt a physician to place an order for Aspirin for the patient and the process terminates.

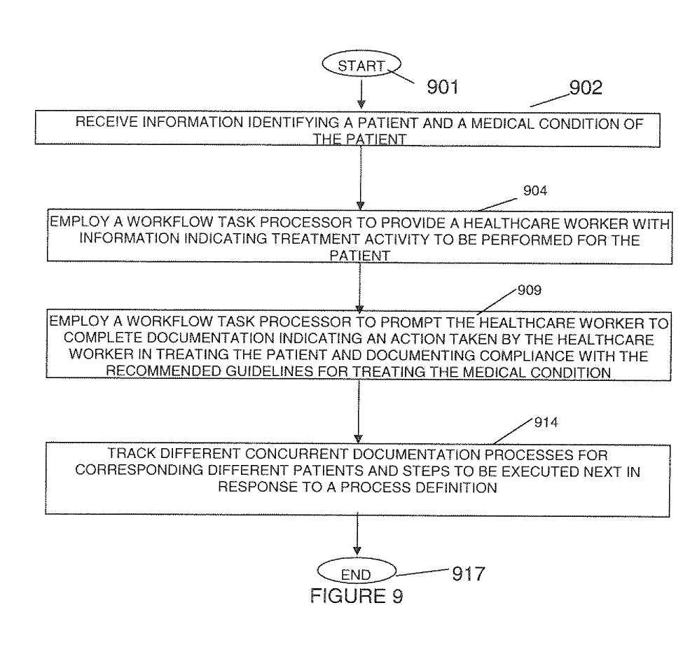

FIG. 9 shows a flowchart of a process performed by medical treatment compliance monitoring system 10 (FIG. 1). In step 902 following the start at step 901, input processor 25 receives information identifying a patient and a medical condition of the patient. Input processor 25 identifies a candidate patient for monitoring by the medical treatment compliance monitoring system in response to at least one of, (a) a main medical condition of a patient, (b) patient laboratory test values, (c) patient diagnosis on admission and (d) patient medical history. Workflow task processor 15 executes in response to predetermined process definitions to determine tasks to add to a worker task list and manage processes responsive to events including at least one of, (a) patient admission to a hospital, (b) start of documentation of an activity and (c) ordering a medication to be administered to a patient. An event monitor in processor 15 detects occurrence of the events based on received event associated data from healthcare information system 35.

Workflow task processor 15 in step 904 provides a healthcare worker with information indicating treatment activity to be performed for the patient that is in conformance with recommended guidelines for treating the medical condition. Processor 15 in step 909 prompts the healthcare worker (e.g., via a message in a displayed image) to complete documentation indicating an action taken by the healthcare worker in treating the patient and documenting compliance with the recommended guidelines for treating the medical condition. The action taken by the healthcare worker comprises an AMI treatment action comprising at least one of, (a) providing Aspirin and (b) smoking cessation counseling, for example. Processor 15 initiates sending a data collection form (automatically pre-populated by the system with previously acquired patient information) to the healthcare worker to document performance of a treatment action taken by the healthcare worker in treating the patient and documenting compliance with the recommended guidelines for treating the medical condition. The previously acquired patient information indicates characteristics associated with the action taken by the healthcare worker. In addition, processor 15 prompts the healthcare worker to complete documentation indicating a treatment action was not taken.

Processor 15 executes in response to a predetermined process definition in order to add a task to a worker task list, remove a task from a worker task list or to modify a task on a worker task list by determining a sequence of process steps including, start, wait, decision and task allocation steps. Specifically, processor 15 executes in response to a predetermined process definition determining a sequence of process steps including a wait step before sending the data collection form to a healthcare worker to document performance of a treatment activity for a patient. The healthcare worker is prompted to complete the documentation (e.g., the form) at a time substantially close to the time of the action being taken by the healthcare worker (or concurrently with attendance to the patient for performing the treatment action) in response to received data identifying the medical condition of the patient. The time substantially close to the time of the action being taken by the healthcare worker comprises at least one of, concurrently with the action being taken, within an hour of the action being taken, within a day of the action being taken and prior to discharge of the patient. In step 914 processor 15 tracks different concurrent documentation processes for corresponding different patients as well as steps to be executed next in response to a process definition. The process of FIG. 9 terminates at step 917.

The system, processes and image displays of FIGS. 1-9 are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. A regulation compliance monitoring system in accordance with invention principles may be used in different data processing areas such, as in industry involving other regulatory regimes. The processes and applications operating on server 20 (FIG. 1) may in alternative embodiments, be located on one or more (e.g., distributed) processing devices accessing the network shown in FIG. 1 or remotely accessible from this network. Further, any of the functions and steps provided in FIGS. 1-9 may be implemented in hardware, software or a combination of both and may reside on one or more processing devices located at any location of a network linking the FIG. 1 elements or another linked network including another intra-net or the Internet.

What is claimed is:

1. A medical treatment compliance monitoring system, comprising:
an input processor for receiving information identifying a patient and a medical condition of said patient; and
a workflow task processor for,
providing a healthcare worker with information indicating treatment activity to be performed for said patient, said treatment activity being in conformance with recommended guidelines for treating said medical condition and
prompting said healthcare worker to complete documentation indicating an action taken by said healthcare worker in treating said patient, and documenting compliance with said recommended guidelines for treating said medical condition, said healthcare worker being prompted to complete said documentation at a time substantially close to the time of said action being taken by said healthcare worker in response to received data identifying said medical condition of said patient.

2. A system according to claim 1, wherein
said documentation indicating said action taken by said healthcare worker comprises a form automatically pre-populated by said system with previously acquired patient information.

3. A system according to claim 2, wherein
said previously acquired patient information indicates characteristics associated with said action taken by said healthcare worker.

4. A system according to claim 2, wherein
said action taken by said healthcare worker comprises at least one of,
(a) providing Aspirin and (b) smoking cessation counseling.

5. A system according to claim 1, wherein
said workflow task processor prompts said healthcare worker to complete documentation indicating a treatment action was not taken.

6. A system according to claim 1, wherein
said workflow task processor prompts said healthcare worker to complete documentation via a message in a displayed image.

7. A system according to claim 1, wherein
said time substantially close to the time of said action being taken by said healthcare worker comprises at least one of, (a) concurrently with said action being taken and (b) within an hour of said action being taken.

8. A system according to claim 1, wherein
said time substantially close to the time of said action being taken by said healthcare worker comprises at least one of, (a) within a day of said action being taken and Q) prior to discharge of said patient.

9. A system according to claim 1, wherein
said input processor identifies a candidate patient for monitoring by said medical treatment compliance monitoring system in response to at least one of, (a) a main medical condition of a patient, (b) patient laboratory test values, (c) patient diagnosis on admission and (d) patient medical history.

10. A system according to claim 1, wherein
said workflow task processor includes an event monitor for identifying events including at least one of, (a) patient admission to a hospital, (b) start of documentation of an activity and (c) ordering a medication to be administered to a patient, using data from a Healthcare Information System.

11. A system according to claim 1, wherein
said workflow task processor tracks different concurrent documentation processes for corresponding different patients and steps to be executed next in response to a process definition.

12. A medical treatment compliance monitoring system, comprising:
an input processor for receiving information identifying a patient and a medical condition of said patient; and
a workflow task processor executes in response to predetermined process definitions to determine tasks to add to a worker task list and manage processes responsive to events including at least one of,
(a) patient admission to a hospital,
(b) start of documentation of an activity and
(c) ordering a medication to be administered to a patient, for,
providing a healthcare worker with information indicating treatment activity to be performed for said patient, said treatment activity being in conformance with recommended guidelines for treating said medical condition and
prompting said healthcare worker to complete documentation indicating an action taken by said healthcare worker in treating said patient, and documenting compliance with said recommended guidelines for treating said medical condition, said healthcare worker being prompted to complete said documentation at a time substantially close to the time of said action being taken by said healthcare worker in response to received data identifying said medical condition of said patient.

13. A system according to claim 12, including
an event monitor for detecting occurrence of said events based on received event associated data from a healthcare information system.

14. A system according to claim 12, including
said workflow task processor executes in response to predetermined process definitions determining a sequence of process steps including two or more of,
(a) start, (b) wait, (c) decision and (d) task allocation steps.

15. A system according to claim 12, including
said workflow task processor executes in response to a predetermined process definition determining a sequence of process steps including a wait step before sending a data collection form to a healthcare worker to document performance of a treatment activity for a patient.

16. A system according to claim 12, including
said workflow task processor executes in response to a predetermined process definition determining a sequence of process steps to add a task to a worker task list and to remove a task from a worker task list.

17. A system according to claim 16, including
said work flow task processor executes in response to a predetermined process definition determining a sequence of process steps to modify a task on a worker task list.

18. A medical treatment compliance monitoring system, comprising:
an input processor for receiving information identifying a patient and a medical condition of said patient; and
a workflow task processor executes in response to predetermined process definitions to determine tasks to add to a worker task list and manage processes responsive to event associated data from a healthcare information system indicating occurrence of an event, for,
providing a healthcare worker with information indicating treatment activity to be performed for said patient, said treatment activity being in conformance with recommended guidelines for treating said medical condition and
initiating sending a data collection form to a healthcare worker to document performance of a treatment action taken by said healthcare worker in treating said patient, and documenting compliance with said recommended guidelines for treating said medical condition, said healthcare worker being prompted to complete said documentation at a time substantially close to the time of said action being taken by said healthcare worker in response to received data identifying said medical condition of said patient.

19. A system according to claim 18, wherein
said workflow task processor tracks different concurrent documentation processes for corresponding different patients and steps to be executed next in response to a process definition.
